(19) United States
(12) Patent Application Publication
(10) Pub. No.: US 2012/0210306 A1
(43) Pub. Date: Aug. 16, 2012

(54) System and Method for Application Testing

(75) Inventors: Neal E. Tucker, Seattle, WA (US); Todd Greenwood-Geer, Seattle, WA (US)

(73) Assignee: Zumobi, Inc., Seattle, WA (US)

(21) Appl. No.: 12/327,690

(22) Filed: Dec. 3, 2008

(51) Int. Cl. G06F 9/44; G06F 15/16

(52) U.S. Cl. 717/126; 709/205

(57) ABSTRACT

The present invention is directed to a system and method which allows applications that are otherwise not addressable by a network to be accessed and tested via the network. For test purposes, an Application Under Test (AUT) is bundled with a several components that allow a Test Server (TS) to access the AUT as if the AUT were directly addressable via the network. In one embodiment, the AUT is bundled with a Client Proxy (CP). The client proxy is also limited in that it also is not addressable by the test server. However, the client proxy can make outgoing socket connections (HTTP, in this implementation). The client proxy queries a Server Proxy (SP) for queued requests, sends the appropriate commands to the AUT, and then responds to the SP with the results. The combination of the SP and the CP, working in tandem, abstract the network connection to the device and provide a virtual connection to the AUT. To the TS, there is a socket (HTTP) connection directly to the device, and thus the methods are invoked directly on the device.

### TECHNICAL FIELD

This disclosure relates to application testing and more specifically to systems and methods for driving a set of tests against a software application and even more specifically to systems and methods for performing network testing of applications and devices that do not have network address visibility.

### BACKGROUND OF THE INVENTION

Mobile devices, such as cellular telephones, PCs, PDAs and the like, typically have software loaded thereon by the device manufacturer or by an intermediary. When such software is loaded on a device, it is necessary to test the software to be sure it is operable. It is also necessary to test such software before it is loaded on a device, for example, when the software is being developed to be sure that it will work properly and without interference with other operations of the device. Note that while software is being discussed in the example, any form of application coding, such as firmware, ASICS, etc., will have the same requirements, and the term software is meant to cover all forms of application coding and/or control.

Generally with software which is designed to run on any platform, the designer must be able to verify accuracy of the application with respect to inputs sent to or received from the platform. This verification relies on the ability to apply input parameters to the platform while the platform is in its normal operating environment. However, in the case of wireless technology, the normal operating environment for the telephone platform on which the software will operate includes a communication network which is not normally available to a software design team. For example, in a cellular telephone a software application designer cannot normally create an incoming call over the network in order to send commands to the telephone. The problem is compounded in that often the software is designed and tested externally to an actual wireless device. Thus, even having access to a cellular network will not help when the software is not yet embedded in an actual device.

### BRIEF SUMMARY OF THE INVENTION

Various embodiments of the present invention are directed to a system and method and computer program product which allows applications that are otherwise not addressable by a network to be accessed and tested via the network. For test purposes, an Application Under Test (AUT) is bundled with several components that allow a Test Server (TS) to access the AUT as if the AUT were directly addressable via the network. In one embodiment, the AUT is bundled with a Client Proxy (CP). The client proxy is also limited in that it also is not addressable by the test server. However, the client proxy can make outgoing socket connections (Hyper Text Transfer Protocol—HTTP, in this example implementation). The client proxy queries a Server Proxy (SP) for queued requests, sends the appropriate commands to the AUT, and then responds to the SP with the results. The combination of the SP and the CP, working in tandem, abstract the network connection to the device and provide a virtual connection to the AUT. To the TS, there is a socket (HTTP) connection directly to the device, and thus the methods are invoked directly on the device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a system for using the concepts of the invention in one test environment;

FIG. 2 shows one embodiment of a test method; and

FIG. 3 shows a computer system on which embodiments of the invention may be implemented.

### DETAILED DESCRIPTION OF THE PREFERRED EMBODIMENT

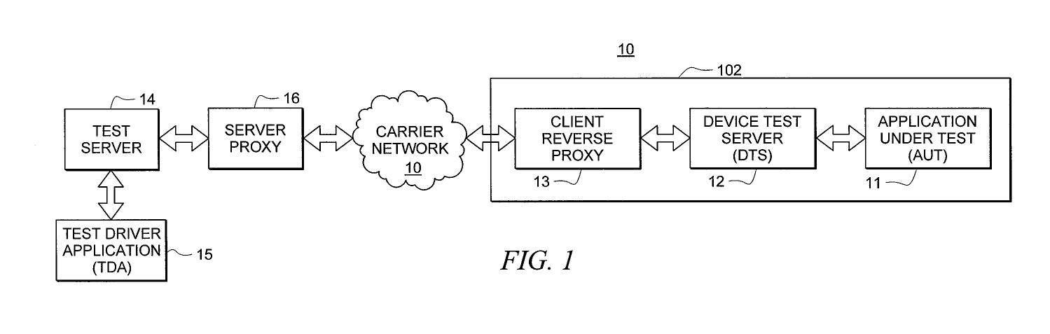

FIG. 1 shows one embodiment of a system, such as system 10, having AUT 11. AUT 11 is assigned, manually or under system control, to Device Test Server (DTS) 12 which presents to a TS, such as TS 14, either directly or in combination with HTTP reverse proxy 13, a particular Application Program Interface (API) to the network. This then signifies to the test server that a particular application has a set of functionalities that the application design team has decided should be tested to discern if it will perform properly in a particular communication network setting. This then allows the TS to make, for example, an HTTP request to AUT 11. The sequence of this is as follows:
1. CP 13, DTS 12 and AUT 11 are installed on the device, such as device 102. As part of such installation, a configuration file is placed on the device detailing which DTS 12 to use, as well as the client device's unique name.
2. CP 13 is started, and the DTS and AUT are started as well (to be discussed hereinafter).
3 CP is a polling proxy. Periodically, it polls the DTS and performs two key functions:
   a) Polls the DTS with a form of ‘keep alive’ that tells the DTS that this device (via the client device's unique name) is connected and can be queried via the proxies. (This polling does not need to pass through the proxies, as the DTS has an addressable IP address). After a specified timeout, the DTS will flush this entry from its cache if the client proxy does not refresh its entry in the cache with a new poll.
   b) The client proxy is also polling server proxy 16 for requests. When the server proxy has a request for the client proxy, it delivers that request to the client proxy as the result of this poll.

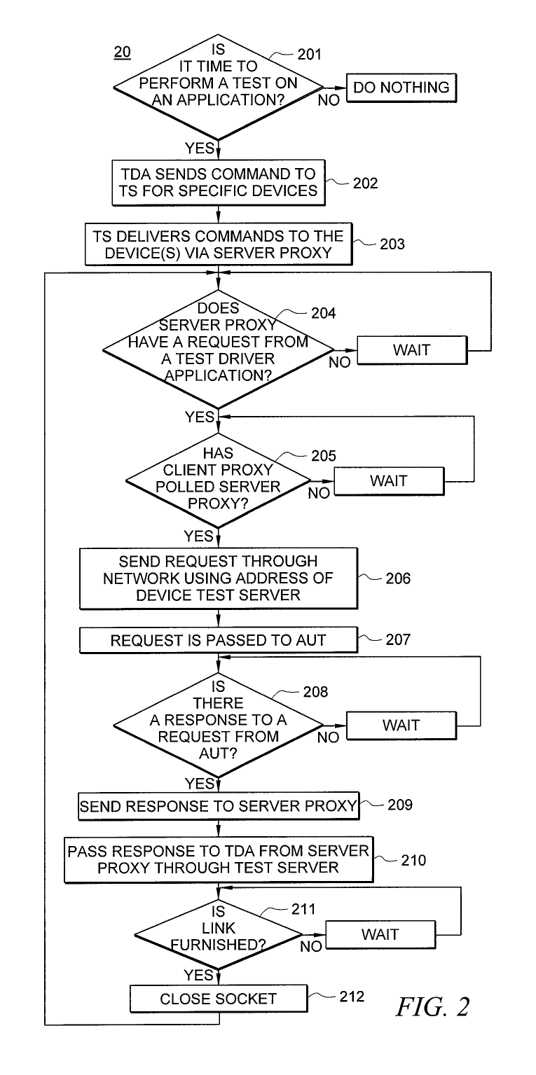

FIG. 2 shows one embodiment of a test method, such as method 20, Process 201 determines if it is time to perform a test on an application. If it is time, then process 202 is performed. When TS 14 makes a request on the AUT, this call can either block or return immediately. The blocking behavior provides a simple user semantic as follows. Test Driver Application (TDA) 15 initiates a test, and sends a command to the TS for execution on (N) devices. Process 203 then could be text server to deliver these commands to (N) devices by sending the request, with the appropriate parameters, to SP 16. SP 16 accepts the socket connection, places the data in a queue, one per device, and then blocks the incoming socket connection. Process 204 determines if a queue is pending.

Process 205 determines if a CP has polled the SP. If so, the request data is extracted from the queue for this device and placed in the response for the client request via process 206 which is passed to the AUT via the DTS via process 207. When process 208 determines that there is a response from the AUT, process 209 sends a second request to the SP, this time with the results from the original, queued request. The SP answers the request, processes 210, 211 and 212 by taking the results from the CP, unblocking the original SP request from the test server, writing the results into the response for the TS, returning that response, and closing the socket connection (standard HTTP).

This presents a clean interface to the TDA and the TS so that by making a call on the AUT, the result will come back. On the other hand the TS may not want to wait on some longer running client activities. In this case, the TS makes a call on the AUT and returns immediately. It is then up to the AUT to post the response back to the TS. This is an example of executing a callback through the server/client proxies 13 and 16. The callback need not pass back through the server/client proxy, as the AUT/DTS can post the results to the publicly addressable TS. An example of this is the eventing architecture within the DTS. The TS may invoke methods on the DTS to add or remove event listeners and events for those listeners. When the AUT or the DTS signals an event, all the listeners are invoked for that event. In the case of the DTS, it packages these events and posts them to the TS.

A bootstrap server (BS) (not shown) is a second example of the TS, SP, CP combination. As part of the testing process, new devices must be inducted into a group of machines that will be associated with a particular TS. The BS is essentially the same thing as the DTS, that is, a webserver attached to an executable, with the purpose of exposing the executable as an invokable object over a socket (HTTP) connection. The process of induction, and the typical use case for the BS is as follows:
1. New device is presented to the test team;
2. The BS, CP, and a config file are installed on the device;
3. The BS is started. From this point forward, there should be no need of manual intervention with the device;
4. The BS starts the CP;
5. The TS, via the SP and the CP, invokes methods on the BS, such as download files, delete local files, start/stop local executables, and return local files;
6. The TS, as part of a test suite, is invoked by the TDA, may do the following:
   Stop the AUT, if present,
   Delete the AUT files, if present,
   Download a new version of the AUT from the network,
   Start the new AUT,
   Invoke a series of methods on the AUT,
   Send key strokes to the AUT,
   Query the AUT for status, screenshots, memory usage, etc.,
   Stop the AUT, and
   Get the log files from the AUT and other systems.

With this level of automation and control, the TDA can continuously run any series of tests, against any version of the AUT, on any subset of the devices under control by the TS.

The server proxy/client proxy combination provides a transparent socket (HTTP) connection from the TS to the DTS. However, the DTS does not require the proxies if it has an addressable network address. The DTS is essentially a web server that resides on the device. The layering of this mechanism is as follows:
1. In the embodiment being discussed, all of our connectivity rides over TCP/IP, specifically sockets;
2. For simplicity, the embodiment uses the HTTP protocol;
3. Again, for simplicity, this connection can be abstracted to use remote procedure calls (RPC); and
4. The data across the RPC connection as Java Script Object Notification (JSON) is bundled (marshalled), although Standard ML Programming Language (SML) could have as easily been used.

As discussed, the DTS is a small webserver that is used to provide remote invocation of whatever application it is attached to, be it the AUT or the BS. In both of these implementations, the DTS is an in-process Dynamic Link Library (DLL) file to the AUT and the BS. But it does not have to be. The DTS could use a variety of means to communicate with the target application, but the simplest approach has been to make it an in-process DLL.

The actual transport between DTS 12 and TS 14 can be any suitable protocol, such as Short Message Service (SMS), TCB socket, provided that the DTS's HTTP interface is presented to the TS. Any method of embedding HTTP information inside another message will work.

Note that the test driver application can be scaled because it can provide the same (or different) test sequences to any number of devices, just so long as each device presents an HTTP address. Thus, each device simply appears to be an HTTP server that is accessible directly from a test application. Each device test server has a corresponding HTTP listener on TS 14 to accept addresses for its associated AUT. In a preferred embodiment the HTTP addresses are manually allocated on the TS but this process could be automated.

With proper security, the metadata pertaining to an HTTP address of a device can be stored on a TS and the metadata could, for example, contain data on applications on particular devices, what carrier the device is assigned to, what kind of hand set, what operating system, etc. Then a user makes a request to the TS indicating an access to the devices of a particular operating system or manufacturer. Those messages are then relayed via the HTTP connector to the devices.

When implemented via computer-executable instructions, various elements of embodiments of the present invention are in essence the software code defining the operations of such various elements. The executable instructions or software code may be obtained from a readable medium (e.g., a hard drive media, optical media, RAM, EPROM, EEPROM, tape media, cartridge media, flash memory, ROM, memory stick, and/or the like). In fact, readable media can include any medium that can store information.

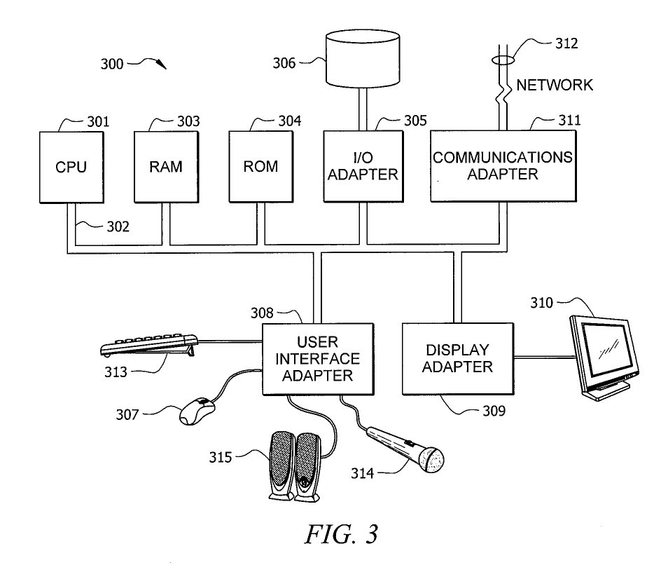

FIG. 3 illustrates an example computer system 300 adapted according to one embodiment of the present invention. That is, computer system 300 comprises an example system on which embodiments of the present invention may be implemented (such as device 102, TDA 15, TS 14, and SP 16 of the example implementation of FIG. 1). Central Processing Unit (CPU) 301 is coupled to system bus 302. CPU 301 may be any general purpose or specialized purpose CPU. However, the present invention is not restricted by the architecture of CPU 301 as long as CPU 301 supports the inventive operations as described herein. CPU 301 may execute the various logical instructions according to embodiments of the present invention. For example, one or more CPUs, such as CPU 301, may execute machine-level instructions according to the exemplary operational flow described above in conjunction with FIG. 2.

Computer system 300 also preferably includes random access memory (RAM) 303, which may be SRAM, DRAM, SDRAM, or the like. In this example, computer system 300 uses RAM 303 to store requests and responses. Computer system 300 preferably includes read-only memory (ROM) 304 which may be PROM, EPROM, EEPROM, or the like. RAM 303 and ROM 304 hold user and system data and programs, as is well known in the art.

Computer system 300 also preferably includes input/output (I/O) adapter 305, communications adapter 311, user interface adapter 308, and display adapter 309. I/O adapter 305, user interface adapter 308, and/or communications adapter 311 may, in certain embodiments, enable a user to interact with computer system 300 in order to input information, such as selection of tests to be run.

I/O adapter 305 preferably connects to storage device(s) 306, such as one or more of hard drive, compact disc (CD) drive, floppy disk drive, tape drive, etc. to computer system 300. The storage devices may be utilized when RAM 303 is insufficient for the memory requirements associated with storing media data. Communications adapter 311 is preferably adapted to couple computer system 300 to network 312 (e.g., the Internet, a LAN, a cellular network, etc.). User interface adapter 308 couples user input devices, such as keyboard 313, pointing device 307, and microphone 314 and/or output devices, such as speaker(s) 315 to computer system 300. Display adapter 309 is driven by CPU 301 to control the display on display device 310 to, for example, display test results.

It should be noted that the exact configuration of a portion of a system according to various embodiments may be slightly different. For example, devices according to one or more embodiments may be any kind of processor-based device, such as a general-purpose computer, a cell phone, a Personal Digital Assistant, and/or the like. Additionally, servers (e.g., servers 14 and 16) according to one or more embodiments may be any kind of processor-based device capable of sending data, such as a personal computer, a server-type computer, and the like. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for testing applications that require network connections, said system comprising:
a test server having associated therewith at least one test sequence for presentation to an application resident on a particular device remote from said test server; and
at least one proxy for allowing a selected one of said test sequences to be delivered to a particular device even though said particular device does not have a network address.

2. The system of claim 1 wherein at least one of said proxies is located at said particular device.

3. The system of claim 2 wherein said device proxy initiates a connection to proxy serving said test server and maintains said connection available for communication there between.

4. The system of claim 2 wherein said test server proxy stores test sequences for delivery to a device upon query from said device proxy.

5. The system of claim 4 wherein said test device proxy forwards test sequences delivered from said test server proxy to an application at said device for testing said application and wherein said test device proxy sends results of said application testing to said test server proxy.

6. The system of claim 4 wherein said test server proxy is arranged to forward test results from said device proxy to said test server.

7. The system of claim 2 wherein data exchange between said proxies uses HTTP protocol over a data network.

8. A method of accessing an application from a location remote from said application, said application residing in an environment in which allows outgoing network addressable connections but not incoming network addressable connections, said method of accessing comprising:
accessing a remote location from said application from time to time to determine if a test sequence is available for delivery to said application via said network from said remote location; and
sending to said application any queued test sequences.

9. The method of claim 8 wherein said accessing comprises:
establishing a network connection from a proxy located on a device upon which said application resides to a test server proxy.

10. The method of claim 9 further comprising:
communicating test results from said device proxy to said test server proxy over said established communication connection; and
forwarding said test results from said test server proxy to said test server.

11. The method of claim 10 wherein said test sequence is posted on said test server proxy for delivery to a plurality of applications located on a plurality of devices.

12. The method of claim 10 further comprising:
accepting at said server a reply to a request from an application.

13. The method of claim 12 further comprising:
forwarding said accepted reply to said testing application.

14. The method of claim 13 further comprising:
a database of test applications and wherein particular test applications are forwarded to said test server from said database.

15. The method of claim 14 wherein said test results are forwarded to said database via said test server.

16. A computer program product having a computer readable medium having computer program logic recorded thereon for testing applications on a device, said computer program product comprising:
code for assigning to said device an interface for communicating with remote locations via a public network, said device having an ability to establish an address known to and accessible to locations remote from said device via said network; and
code for making said established address known to at least one remote location such that said remote location can access said device via said established address for a limited period of time.

17. The computer program product of claim 16 wherein said network comprises the Internet and wherein said address uses the HTTP protocol.

18. The computer program product of claim 17 wherein said interface acts as an intermediary between said remote device and a testing application.

19. The computer program product of claim 18 wherein said address establishing code comprises:
code for sending at least one request to a specific remote device.

20. The computer program product of claim 19 wherein said request comprises:
a request for test sequence queries stored at said remote location, said queries stored as a result of a communication between said remote device and a testing application.

21. The computer program product of claim 20 wherein said testing application communicates a plurality of test sequence requests for delivery to a applications located on a plurality of devices.
